(19) United States
(12) Patent Application Publication
(10) Pub. No.: US 2026/0149544 A1
(43) Pub. Date: May 28, 2026

(54) METHOD AND APPARATUS FOR PORT MAPPING OF SOUNDING REFERENCE SIGNAL RESOURCE, AND TERMINAL

(71) Applicant: VIVO MOBILE COMMUNICATION CO., LTD., Dongguan (CN)

(72) Inventors: Kaili ZHENG, Dongguan (CN); Hao WU, Dongguan (CN); Yang SONG, Dongguan (CN)

(21) Appl. No.: 19/450,780

(22) Filed: Jan. 16, 2026

Related U.S. Application Data
(63) Continuation of application No. PCT/CN2024/106215, filed on Jul. 18, 2024.

(30) Foreign Application Priority Data
Jul. 19, 2023 (CN) 202310893914.4

(51) Int. Cl. H04L 5/00; H04J 13/00; H04L 27/26

(52) U.S. Cl. CPC H04L 5/0051; H04J 13/004; H04L 27/2605

(57) ABSTRACT

Provided are a method and an apparatus for port mapping of a sounding reference signal SRS resource, and a terminal. A method for port mapping of an SRS resource includes following steps. A terminal sends an SRS resource. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

### CROSS-REFERENCE TO RELATED APPLICATIONS

This application is a continuation of International Patent Application No. PCT/CN2024/106215, filed on Jul. 18, 2024, which claims priority to Chinese Patent Application No. 202310893914.4, filed with the China National Intellectual Property Administration on Jul. 19, 2023 and entitled “METHOD AND APPARATUS FOR PORT MAPPING OF SOUNDING REFERENCE SIGNAL SRS RESOURCE, AND TERMINAL”, both of which are incorporated herein by reference in their entireties.

### TECHNICAL FIELD

This application relates to the field of communication technologies, and specifically, to a method and an apparatus for port mapping of a sounding reference signal SRS resource, and a terminal.

### BACKGROUND

In a current time division duplex (Time Division Duplex, TDD) system, a network side can enable a non-codebook-based physical downlink shared channel (Physical downlink shared channel, PDSCH) transmission mode. In this transmission mode, the network side performs uplink channel estimation based on a sounding reference signal (Sounding Reference Signal, SRS) sent by a terminal, and determines downlink precoding based on channel reciprocity.

### SUMMARY

The embodiments of this application provide a method and an apparatus for port mapping of an SRS resource, and a terminal.

According to a first aspect, a method for port mapping of a sounding reference signal SRS resource is provided. The method includes: A terminal sends an SRS resource. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

According to a second aspect, an apparatus for port mapping of a sounding reference signal SRS resource is provided. The apparatus includes a transmission module, configured to send an SRS resource. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

According to a third aspect, a method for port mapping of a sounding reference signal SRS resource is provided. The method includes: A network side device receives an SRS resource sent by a terminal. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

According to a fourth aspect, an apparatus for port mapping of a sounding reference signal SRS resource is provided. The apparatus includes a transmission module, configured to receive an SRS resource sent by a terminal. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

According to a fifth aspect, a terminal is provided. The terminal includes a processor and a memory, where the memory stores a program or an instruction that can be run on the processor, and when the program or the instruction is executed by the processor, the steps of the method according to the first aspect are implemented.

According to a sixth aspect, a terminal is provided. The terminal includes a processor and a communication interface, where the communication interface is coupled to the processor, and the processor is configured to run a program or an instruction to implement the steps of the method according to the first aspect.

According to a seventh aspect, a network side device is provided. The terminal includes a processor and a memory, where the memory stores a program or an instruction that can be run on the processor, and when the program or the instruction is executed by the processor, the steps of the method according to the third aspect are implemented.

According to an eighth aspect, a network side device is provided. The network side device includes a processor and a communication interface, where the communication interface is coupled to the processor, and the processor is configured to run a program or an instruction to implement the steps of the method according to the third aspect.

According to a ninth aspect, a readable storage medium is provided. The readable storage medium stores a program or an instruction, and when the program or the instruction is executed by a processor, the steps of the method according to the first aspect or the third aspect are performed.

According to a tenth aspect, a wireless communication system is provided. The wireless communication system includes a terminal and a network side device. The terminal may be configured to perform the steps of the method according to the first aspect, and the network side device may be configured to perform the steps of the method according to the third aspect.

In an eleventh aspect, a chip is provided. The chip includes a processor and a communication interface, where the communication interface is coupled to the processor, and the processor is configured to run a program or an instruction to implement the steps of the method according to the first aspect or the third aspect.

According to a twelfth aspect, a computer program/program product is provided. The computer program/program product is stored in a storage medium, and the program/program product is executed by at least one processor to implement the steps of the method according to the first aspect or the third aspect.

### BRIEF DESCRIPTION OF DRAWINGS

FIG. 1 is a schematic structural diagram of a wireless communication system provided in an example embodiment of this application;

FIG. 2 is a first schematic flowchart of a method for port mapping of an SRS resource provided in an example embodiment of this application;

FIG. 3 is a second schematic flowchart of a method for port mapping of an SRS resource provided in an example embodiment of this application;

FIG. 4a is a first schematic diagram of port mapping provided in an example embodiment of this application;

FIG. 4b is a second schematic diagram of port mapping provided in an example embodiment of this application;

FIG. 4c is a third schematic diagram of port mapping provided in an example embodiment of this application;

FIG. 4d is a fourth schematic diagram of port mapping provided in an example embodiment of this application;

FIG. 4e is a fifth schematic diagram of port mapping provided in an example embodiment of this application;

FIG. 5 is a third schematic flowchart of a method for port mapping of an SRS resource provided in an example embodiment of this application;

FIG. 6 is a first schematic structural diagram of an apparatus for port mapping of an SRS resource according to an example embodiment of this application;

FIG. 7 is a second schematic structural diagram of an apparatus for port mapping of an SRS resource according to an example embodiment of this application;

FIG. 8 is a schematic diagram of a communication device provided in an example embodiment of this application;

FIG. 9 is a schematic structural diagram of a terminal provided in an example embodiment of this application; and

FIG. 10 is a schematic structural diagram of a network side device provided in an example embodiment of this application.

### DESCRIPTION OF EMBODIMENTS

The following clearly describes the technical solutions in the embodiments of this application with reference to the accompanying drawings in the embodiments of this application. Clearly, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are unnecessarily used to describe a specific order or sequence. It should be understood that, the terms used in such a way are interchangeable in appropriate circumstances, so that the embodiments of this application can be implemented in an order other than the order illustrated or described herein. Objects classified by “first” and “second” are usually of a same type, and a number of objects is not limited. For example, there may be one or more first objects. In addition, “or” used in this application means at least one of connected objects. For example, “A or B” covers three solutions, that is, a solution 1: including A but not including B; a solution 2: including B but not including A; and a solution 3: including both A and B. The character “/” generally represents an “or” relationship between the associated objects.

The term “indication” in this application may be a direct indication (or an explicit indication) or an indirect indication (or an implicit indication). A direct indication may be understood as that, in a sent indication, a sender explicitly notifies a receiver of content such as specific information, an operation that needs to be performed, or a request result. An indirect indication may be understood as that, a receiver determines corresponding information based on an indication sent by a sender, or determines, based on a determining result, an operation that needs to be performed, a request result, or the like.

It should be noted that technologies described in the embodiments of this application are not limited to a long term evolution (Long Term Evolution, LTE)/LTE-Advanced (LTE-Advanced, LTE-A) system, and may be further applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of this application may be used interchangeably. The technologies described can be applied to both the systems and the radio technologies mentioned above, as well as to other systems and radio technologies. A new radio (New Radio, NR) system is described in the following description for illustrative purposes, and the NR terminology is used in most of the following description, although these technologies can also be applied to systems other than the NR system, such as the 6^{th} generation (6^{th} Generation, 6G) communication system.

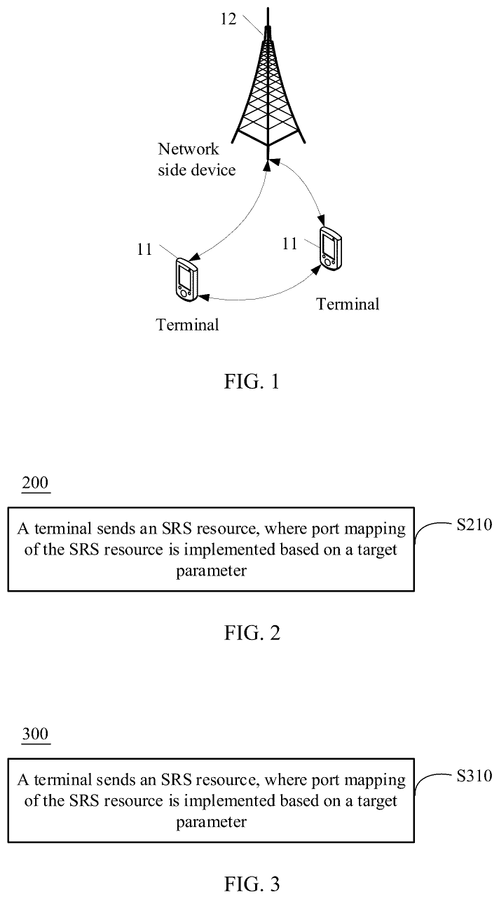

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR)/virtual reality (Virtual Reality, VR) device, a robot, a wearable device (Wearable Device), a flight vehicle (flight vehicle), vehicle user equipment (Vehicle User Equipment, VUE), a shipboard device, pedestrian user equipment (Pedestrian User Equipment, PUE), a smart home (a home device with a wireless communication function, such as a refrigerator, a television, a washing machine, or a furniture), a game console, a personal computer (Personal Computer, PC), a teller machine, or a self-service machine. The wearable device includes: a smart watch, a smart band, a smart headset, smart glasses, smart jewelry (a smart bracelet, a smart hand chain, a smart ring, a smart necklace, a smart anklet, a smart ankle chain), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a Node B (Node B, NB), an evolved Node B (Evolved Node B, eNB), a next-generation Node B (the next generation Node B, gNB), a new radio Node B (New Radio Node B, NR Node B), an access point, a relay station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home Node B (home Node B, HNB), a home evolved Node B (home evolved Node B), a transmission reception point (Transmission Reception Point, TRP), or another appropriate term in the field. As long as a same technical effect is achieved, the base station is not limited to a specified technical term. It should be noted that, in this application, only a base station in an NR system is used as an example, and a specific type of the base station is not limited.

The technical solutions provided in the embodiments of this application are described in detail below with reference to the accompanying drawings by using some embodiments and application scenarios thereof.

FIG. 2 is a schematic flowchart of a method 200 for port mapping of an SRS resource provided in an example embodiment of this application. The method 200 may be performed by a terminal, but is not limited thereto. Specifically, the method may be performed by hardware or software installed in the terminal. In this embodiment, the method 200 may include at least the following step.

S210: The terminal sends an SRS resource.

The SRS resource may be used for, but not limited to, channel estimation by a network side. In this embodiment, mapping of a port of the SRS resource (which may also be referred to as an SRS port) may be implemented based on a target parameter, to improve flexibility of port multiplexing and increase an SRS capacity.

In this embodiment, the target parameter may include at least one of a first parameter and a second parameter. That is, port mapping may be performed based on only the first parameter or the second parameter, or performed based on both the first parameter and the second parameter. This is not limited.

The first parameter may include a Doppler domain-related parameter or an orthogonal cover code (Orthogonal Cover Code, OCC) sequence-related parameter. It may be understood that, Doppler domain is a domain corresponding to discrete Fourier transform (Discrete Fourier Transform, DFT) performed for time domain. Based on this, in this embodiment, the Doppler domain-related parameter may include but is not limited to a cyclic shift (cyclic shift) parameter in Doppler domain, a frequency offset parameter in Doppler domain, a phase parameter in Doppler domain, and the like.

An OCC sequence may be a time division OCC (Time Division OCC, TD-OCC) sequence. Performing port mapping based on the TD-OCC sequence in time domain and performing port mapping based on the Doppler domain-related parameter in Doppler domain may be understood as an equivalent relationship. For example, different Doppler domain-related parameters correspond to different TD-OCC sequences in time domain.

That is, in this embodiment, performing port mapping of the SRS resource based on the Doppler domain-related parameter or the OCC sequence-related parameter may be understood as adding a mapping dimension, namely, Doppler domain during the port mapping. This can improve flexibility of port multiplexing, and further improve an SRS capacity of a communication system.

The second parameter includes a time domain-related parameter, for example, a symbol interval and a punctured symbol for performing port mapping for the SRS resource. It may be understood that, in this embodiment, performing port mapping for the SRS resource based on the time domain-related parameter (such as the symbol interval and the punctured symbol) can implement port multiplexing between a plurality of SRS resources, thereby improving the SRS capacity of the communication system.

It should be noted that, in this embodiment, when port mapping is performed based on the target parameter, port multiplexing may be implemented based on different target parameters in a single SRS resource or between the plurality of SRS resources. This is not limited herein.

In this embodiment, performing the port mapping of the SRS resource based on the target parameter can further optimize the method for SRS port mapping, thereby ensuring flexibility of port multiplexing of the SRS resource, and improving the SRS capacity of the entire communication system.

FIG. 3 is a schematic flowchart of a method 300 for port mapping of an SRS resource provided in an example embodiment of this application. The method 300 may be performed by a terminal, but is not limited thereto. Specifically, the method may be performed by hardware or software installed in the terminal. In this embodiment, the method 300 may include at least the following step.

S310: The terminal sends an SRS resource, where port mapping of the SRS resource is implemented based on a target parameter.

The target parameter includes at least one of a first parameter and a second parameter, the first parameter includes a Doppler domain-related parameter or an OCC sequence-related parameter, and the second parameter includes a time domain-related parameter.

It may be understood that, for an implementation process of S310, in addition to referring to the foregoing related descriptions of the foregoing embodiment of the method 200, in a possible implementation, for different target parameters, there is a difference in the port mapping of the SRS resource. The following separately describes the different target parameters.

In a case that the target parameter includes the first parameter, (such as the Doppler domain-related parameter or the OCC sequence-related parameter), configuration manners of the first parameter may include at least one of the following manner 1 and manner 2.

Manner 1: The terminal receives first signaling, where the first signaling indicates a third parameter, there is an association relationship between the third parameter and M first parameters, and M is an integer greater than or equal to 1 and less than or equal to N; and N is a number of ports of the SRS resource. In other words, in manner 1, the first parameter may be implicitly indicated by the third parameter, so that signaling can be saved while the first parameter is indicated.

The first signaling may be but is not limited to radio resource control (Radio Resource Control, RRC) signaling, or the like.

In an implementation, before the third parameter is indicated by the first signaling, the association relationship between the third parameter and the first parameter may be determined or configured in different manners. For example, in this embodiment, the association relationship between the third parameter and the M first parameters may be determined through at least one of (11) to (13).
(11) Default agreement between a network side and the terminal (also referred to as negotiation-based determination).

For example, it is assumed that the SRS resource has N=8 ports, and the first parameter is the Doppler domain-related parameter.

When the third parameter has a value of A, it may be agreed by default that there is an association relationship between the third parameter and two Doppler domain-related parameters: d1 and d2. In this case, a part of the eight ports correspond to the Doppler domain-related parameter d1, and a part of the eight ports correspond to the Doppler domain-related parameter d2. For example, four of the eight ports correspond to the Doppler domain-related parameter d1, and the other four ports correspond to the Doppler domain-related parameter d2.

When the third parameter has a value of B, it may be agreed by default that there is an association relationship between the third parameter and two Doppler domain-related parameters: d3 and d4. In this case, a part of the eight ports correspond to the Doppler domain-related parameter d3, and a part of the eight ports correspond to the Doppler domain-related parameter d4. For example, four of the eight ports correspond to the Doppler domain-related parameter d3, and the other four ports correspond to the Doppler domain-related parameter d4.

The rest may be deduced by analogy.
(12) Autonomous determining by the terminal.

For example, it is assumed that the SRS resource has N=8 ports, and the first parameter is the Doppler domain-related parameter. The terminal may autonomously determine that there is an association relationship between a third parameter with a value of A and two Doppler domain-related parameters d1 and d2, and there is an association relationship between a third parameter with a value of B and Doppler domain-related parameters d3 and d4. In this case, to ensure that the network side and the terminal have consistent understanding on the association relationships, the terminal can report the association relationships to the network side device after autonomously determining the association relationships, to indicate the third parameter.
(13) Configuration by a network side.

For example, it is assumed that the SRS resource has N=8 ports, and the first parameter is the Doppler domain-related parameter. When the third parameter has a value of A, a Doppler domain-related parameter associated with the third parameter may be configured through RRC signaling. For example, Doppler domain-related parameters d1 and d3 are configured to be associated with the value of A through RRC signaling, and Doppler domain-related parameters d2 and d4 are configured to be associated with a value of B through RRC signaling. This is not limited herein.

Manner 2: The terminal receives second signaling, where the second signaling indicates L first parameters, and L is an integer greater than or equal to 1 and less than or equal to N, and N is a number of ports of the SRS resource.

The port mapping of the SRS resource is performed based on the number of first parameters. In a case that L is equal to N, N ports each may use one first parameter. For another example, in a case that L is an integer less than N, at least a part of N ports share one of the first parameters.

For example, in a case that L is an integer equal to N, assuming that the SRS resource has N=8 ports, eight Doppler domain-related parameters, namely, d1, d2, d3, d4, d5, d6, d7, and d8 are configured in the second signaling. Each of the eight Doppler domain-related parameters corresponds to one port.

Alternatively, in a case that L is an integer less than N, assuming that the SRS resource has N=8 ports, two Doppler domain-related parameters, namely, d1 and d2 are configured in the second signaling. Based on a default agreement between a network side and the terminal, four of the eight ports correspond to the Doppler domain-related parameter d1, and the other four ports correspond to the Doppler domain-related parameter d2.

In an implementation, during the port mapping of the SRS resource, in a case that the N ports of the SRS resource correspond to a plurality of first parameters, the plurality of first parameters may satisfy at least one of (21) and (22), to ensure orthogonality of port multiplexing.
(21) Values of the plurality of first parameters are obtained by evenly dividing a preset value range according to a specific value, that is, the values of the plurality of first parameters are equally spaced.

For example, it is assumed that the SRS resource has N=8 SRS ports, and there is an association relationship between the ports and four Doppler domain-related parameters d1, d2, d3, and d4. Values of the Doppler domain-related parameters d1, d2, d3, and d4 are equally spaced.

Based on this, in a case that the port mapping of the SRS resource is performed, ports #0 and #1 correspond to the Doppler domain related parameter d1, ports #2 and #3 correspond to the Doppler domain-related parameter d2, ports #4 and #5 correspond to the Doppler domain-related parameter d3, and ports #6 and #7 correspond to the Doppler domain-related parameter d4.
(22) A total number of the plurality of first parameters does not exceed a preset value, where the preset value is related to at least one of following: the number of ports of the SRS resource, a number of cyclic shifts (Cyclic shifts), and a number of comb offsets (Comb offsets).

For example, it is assumed that the SRS resource has N=8 ports, and a comb structure of the SRS resource is configured as Comb 2. In this case, the ports #0 and #1 are multiplexed based on a cyclic shift #1 and a cyclic shift #2 respectively and mapped to a position of a comb offset #1; the ports #2 and #3 are multiplexed based on the cyclic shift #1 and the cyclic shift #2 respectively and mapped to a position of a comb offset #2; the ports #4 and #5 are multiplexed based on the cyclic shift #1 and the cyclic shift #2 respectively and mapped to the position of the comb offset #1; and the ports #6 and #7 are multiplexed based on the cyclic shift #1 and the cyclic shift #2 respectively and mapped to the position of the comb offset #2. In this case, to implement multiplexing of the eight ports, the total number of the first parameters needs to be 2, that is, the eight ports correspond to Doppler domain-related parameters d1 and d2. In this case, the ports #0, #1, #2, and #3 correspond to the Doppler domain-related parameter d1, and the ports #4, #5, #6, and #7 correspond to the Doppler domain-related parameter d2. In other words, the total number of the first parameters needs to be inferred or determined based on a number of cyclic shifts and a number of comb offsets used for port multiplexing of the SRS resource, to satisfy multiplexing of all ports of the SRS resource.

It should be noted that, when SRS port mapping is performed based on the first parameter, in addition to the foregoing case that N ports of one SRS resource correspond to a plurality of first parameters, in an implementation, each of the N ports of the SRS resource may further correspond to a same first parameter.

For example, in a case that the N ports of the SRS resource correspond to the same first parameter, the N ports may be multiplexed in a first multiplexing scheme. The first multiplexing scheme includes at least one of (31) to (33), to ensure orthogonality of port multiplexing.
(31) Multiplexed based on a cyclic shift, that is, code division multiplexing (Code Division Multiplexing, CDM).
(32) Multiplexed based on a comb offset, that is, frequency division multiplexing (Frequency division multiplexing, FDM).
(33) Multiplexed in time domain, based on a symbol occupied by the SRS resource, that is, time division multiplexing (Time Division Multiplexing, TDM).

For example, in a case that at least a part of the N ports of the SRS resource correspond to different first parameters, the N ports may be multiplexed in a second multiplexing scheme. The second multiplexing scheme includes at least one of (41) to (44), to improve flexibility and a capacity of port multiplexing.
(41) Multiplexed based on a cyclic shift, that is, CDM.
(42) Multiplexed based on a comb offset, that is, FDM.

It may be understood that the cyclic shift and the comb offset in (41) and (42) are frequency-domain parameters.
(43) Multiplexed in time domain, based on symbols occupied by the SRS resource, that is, TDM.
(44) Multiplexed based on the first parameter (namely, the foregoing Doppler domain-related parameter and the foregoing OCC sequence-related parameter).

In an implementation, when N ports of the SRS resource occupy a plurality of symbols, sequence values of the SRS resource mapped to the plurality of symbols are related to the first parameter (namely, the Doppler domain-related parameter and the OCC sequence-related parameter). The sequence values of the SRS resource mapped to the plurality of symbols may be determined by a function with the first parameter as an independent variable. In addition, in this embodiment, the sequence values of the SRS resource mapped to the plurality of symbols may be determined by a time parameter.

For example, the sequence values of the SRS resource mapped to the plurality of symbols may be determined by a function with the Doppler domain-related parameter and the time parameter as independent variables. For example, the sequence values of the SRS resource mapped to the plurality of symbols may be e\hat{ }(j*Doppler domain frequency offset fd*time parameter). Optionally, the time parameter includes at least one of following: a symbol index, a period of symbols, and a number of symbols, that is, a phase of the sequence values of the SRS resource on different symbols rotates with the time parameter.

In this embodiment, in the case that the first parameter includes the OCC sequence-related parameter, in addition to the foregoing relation characteristic, in an implementation, in a case of determining a target OCC sequence based on the OCC sequence-related parameter, ports of the SRS resource may further correspond to the target OCC sequence. For example, a part of the N ports of the SRS resource correspond to one target OCC sequence, implementing port multiplexing of one SRS resource. For another example, all ports of one SRS resource correspond to one target OCC sequence, and all ports of another SRS resource correspond to another target OCC sequence, implementing port multiplexing between the two SRS resources, and the like. This is not limited herein.

It should be noted that, in this embodiment, a manner in which the terminal determines the target OCC sequence based on the OCC sequence-related parameter may include at least one of (51) and (52).
(51) When the OCC sequence-related parameter is configured, different target OCC sequences correspond to different OCC sequence-related parameters, such as the target OCC sequences and the OCC sequence-related parameters are in one-to-one mapping (or in a one-to-one correspondence).
(52) When the OCC sequence-related parameter is not configured, all elements in the target OCC sequence are 1.

In an implementation, each element in the target OCC sequence is in a one-to-one correspondence with a symbol occupied by the SRS resource (namely, a TD-OCC sequence).

It should be noted that, a length of the target OCC sequence may be determined through at least one of (61) to (64).
(61) A number of repetitions of the SRS resource.

For example, assuming that the number of repetitions of the SRS resource is 14, the length of the target OCC sequence is also 14, and a mapping element of the target OCC sequence on each symbol is related to the Doppler domain-related parameter and the time parameter (for example, the symbol index, the period of symbols, and the number of symbols).
(62) A number of symbols occupied by the SRS resource.
(63) A number of slots occupied by the SRS resource. The number of slots occupied by the SRS resource may be a number of slots occupied by one SRS resource or a plurality of SRS resources.

For one SRS resource, the SRS resource occupies a plurality of consecutive slots.

For the plurality of SRS resources, slots occupied by the plurality of SRS resources are consecutive, that is, the plurality of SRS resources correspond to a same OCC sequence, that is, the plurality of SRS resources have a binding relationship.
(64) A fourth parameter, where the fourth parameter is a parameter other than the number of repetitions of the SRS resource, the number of symbols occupied by the SRS resource, and the number of slots occupied by the SRS resource, for example, the length of the target OCC sequence. In other words, the length of the target OCC sequence may alternatively be indicated or determined by the fourth parameter, that is, the length of the target OCC sequence may be different from the number of repetitions of the SRS resource or a length of symbols occupied by the SRS resource. For example, to implement multiplexing of SRS resources of different lengths, the length of the target OCC sequence may be determined by the fourth parameter.

Optionally, the fourth parameter may be configured through, but not limited to, RRC signaling.

In an implementation, in addition to performing the port mapping of the SRS resource based on the foregoing Doppler domain-related parameter and the foregoing OCC sequence-related parameter, in a case of performing the port mapping of the SRS resource based on a second parameter (for example, a time domain-related parameter), the second parameter may alternatively be configured through, but not limited to, RRC signaling.

In addition, in an implementation, in the case that the terminal performs the port mapping of the SRS resource based on the target parameter, the second parameter may be used to determine one of (51) and (52).
(51) A symbol interval between symbols occupied by the SRS resource. In this case, port multiplexing can be implemented between the plurality of SRS resources through configuration of the symbol interval, thereby improving an SRS capacity of an entire communication system.

In this embodiment, the symbol interval may be 0 to 13.

In addition, in a case that the port mapping is performed for the SRS resource based on the symbol interval, a mapping manner may include at least one of (a) and (b).
(a) A start symbol position for performing the port mapping for the SRS resource is determined by a first symbol offset.

For example, in a case that the start symbol position obtained through calculation based on a start position (start Position) parameter configured for the SRS resource is P1, a final start symbol position is determined to be P1+offset based on the first symbol offset.

The first symbol offset is determined through protocol agreement, configuration by a network side, configuration by the terminal, or the like. This is not limited herein.
(b) In a case that the SRS resource is configured with a repetition factor R, the port mapping is repeated R times based on the symbol interval, or is repeated R/X times based on the symbol interval, where R/X is an integer, and X represents the symbol interval.

For example, in a case that the number of repetitions of the SRS resource is 14, and the symbol interval X is 2, an actual number of symbols mapped by the SRS port is 7, and an interval between symbols is 2.
(52) A punctured symbol between the symbols occupied by the SRS resource, which may also be understood as a rate matching pattern (Rate matching pattern). In this case, the port multiplexing can be implemented between the plurality of SRS resources through configuration of the punctured symbol, thereby improving the SRS capacity of the entire communication system.

The punctured symbol is determined based on one of (a) and (b).
(a) a bitmap (bitmap) indication; and
(b) a start position and a puncturing length of the punctured symbol.

It should be noted that, during the port mapping, symbol mapping is not performed for the SRS resource at the position of the punctured symbol. The puncturing length may be understood as a number of symbols that are punctured.

In this embodiment, the solution for the port mapping of the SRS resource is optimized by further improving a channel capacity through Doppler domain port multiplexing, or reducing symbols occupied by the SRS resource through time-domain multiplexing to implement port mapping between the plurality of SRS resources, so that the SRS capacity of the entire communication system is effectively improved.

Based on the descriptions of the embodiments of the methods 200 and 300 for port mapping of the SRS resource, for ease of understanding, the following further describes processes of the methods for port mapping of the SRS resource provided in this application with reference to examples, and content is as follows.

### Example 1

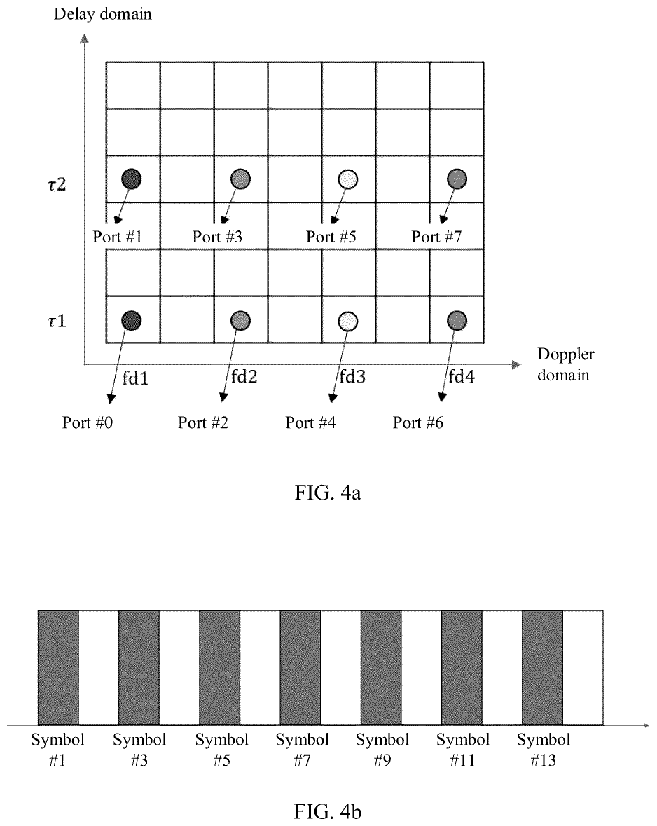

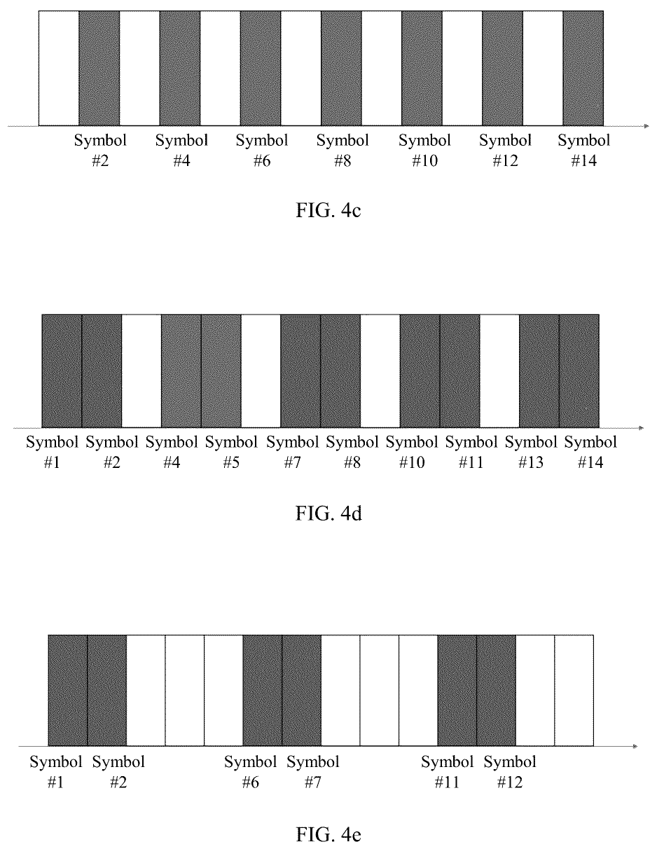

It is assumed that the SRS resource has N=8 ports, where delay domain may be obtained by performing inverse fast Fourier transform (Inverse Fast Fourier Transform, IFFT) for frequency domain, and Doppler domain can be obtained by performing FFT for time domain.
(1) As shown in FIG. 4a, it is assumed that there is one SRS resource with eight ports, where ports #0 and #1 correspond to a same Doppler domain-related parameter and are mapped to a position fd1 in Doppler domain, ports #2 and #3 correspond to a same Doppler domain-related parameter and are mapped to a position fd2 in Doppler domain, ports #4 and #5 correspond to a same Doppler domain-related parameter and are mapped to a position fd3 in Doppler domain, and ports #6 and #7 correspond to a same Doppler domain-related parameter and are mapped to a position fd4 in Doppler domain. In addition, the ports #0, #2, #4, and #6 correspond to a same cyclic shift value and are mapped to a delay position τ1, and the ports #1, #3, #5, and #6 correspond to a same cyclic shift value and are mapped to a delay position τ2, thereby implementing multiplexing of the eight ports.
(2) Refer to FIG. 4a again. It is assumed that there are four SRS resources with two ports, where an SRS resource #1 includes the ports #0 and #1 that correspond to one Doppler domain-related parameter and two cyclic shift values, and are mapped to the position fd1 in Doppler domain and the delay positions τ1 and τ2; an SRS resource #2 includes ports #2 and #3 that correspond to one Doppler domain-related parameter and two cyclic shift values in frequency domain, and are mapped to the position fd2 in Doppler domain and the delay positions τ1 and τ2; an SRS resource #3 includes the ports #4 and #5 that correspond to a same Doppler domain-related parameter and two cyclic shift values in frequency domain, and are mapped to the position fd3 in Doppler domain and the delay positions τ1 and τ2; an SRS resource #4 includes the ports #6 and #7 that correspond to a same Doppler domain-related parameter and two cyclic shift values, and are mapped to the fd4 position in Doppler domain and the delay positions τ1 and τ2, thereby implementing multiplexing of the eight ports.

In addition, the four Doppler domain-related parameters (corresponding to fd1, fd2, fd3, and fd4) are transformed into time domain, resulting in four different target OCC sequences. Therefore, it may also be understood as that the SRS ports are multiplexed in time domain based on the TD-OCC sequence through configuration of the Doppler domain-related parameter. Different TD-OCC sequences correspond to different Doppler domain-related parameters, for example, a frequency offset in Doppler domain.

### Example 2

Assuming that the number of repetitions of the SRS resource is 14, and the port mapping is repeated R times based on the symbol interval, in a case that it is determined by the time domain-related parameter that, the symbol interval X is two symbols and the first symbol offset is 0, a port mapping result of the SRS resource based on the time domain-related parameter is shown in FIG. 4b. In a case that it is determined by the time domain-related parameter that, the symbol interval X is two symbols and the first symbol offset is 1, a port mapping result of the SRS resource based on the time domain-related parameter is shown in FIG. 4c.

### Example 3

It is assumed that the plurality of ports of the SRS resource are mapped to two symbols, for example, |the SRS resource with eight ports are mapped to two symbols through TDM. In a case that it is determined by the time domain-related parameter that, the symbol interval X is two symbols and the first symbol offset is 0, a port multiplexing result of the SRS resource may be shown in FIG. 4d.

### Example 4

It is assumed that the number of repetitions of the SRS resource is 14, and positions of punctured symbols are determined by the time domain-related parameter to be symbols #3, #4, #5, #8, #9, #10, #13, and #14. As shown in FIG. 4e, a bitmap 11000110001100 may be used for an indication. Each bit (bit) corresponds to one symbol.

It may be understood that, the foregoing methods for port mapping of the SRS resource provided in this application may include, but are not limited to, Examples 1 to 4.

FIG. 5 is a schematic flowchart of a method 500 for port mapping of an SRS resource provided in an example embodiment of this application. The method 500 may be performed by a network side device, but is not limited thereto. Specifically, the method may be performed by hardware or software installed in the network side device. In this embodiment, the method 500 may include at least the following step.

S510: The network side device receives an SRS resource sent by a terminal.

Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

Optionally, in a case that the target parameter includes the first parameter, the method further includes at least one of following: sending first signaling to the terminal, where the first signaling is used to indicate a third parameter, there is an association relationship between the third parameter and M first parameters, and M is an integer greater than or equal to 1 and less than or equal to N; and
sending second signaling to the terminal, where the second signaling is used to indicate L first parameters, and L is an integer greater than or equal to 1 and less than or equal to N, where N is a number of ports of the SRS resource.

Optionally, the association relationship between the third parameter and the M first parameters is determined through at least one of following: default agreement between a network side and the terminal; reporting by the terminal; and configuration by a network side.

It may be understood that, the embodiment of the method 500 has the same or corresponding technical feature as the foregoing embodiments of the methods 200 and 300. Therefore, for an implementation process of the foregoing implementations in the embodiment of the method 500, reference may be made to the related descriptions in the foregoing embodiments of the methods 200 and 300, and a same or corresponding technical effect is achieved. To avoid repetition, details are not described herein again.

The methods for port mapping of the SRS resource provided in the embodiments of this application may be performed by an apparatus for port mapping of an SRS resource. An apparatus for port mapping of an SRS resource provided in an embodiment of this application is described by using an example in which the apparatus for port mapping of the SRS resource performs a method for port mapping of an SRS resource according to an embodiment of this application.

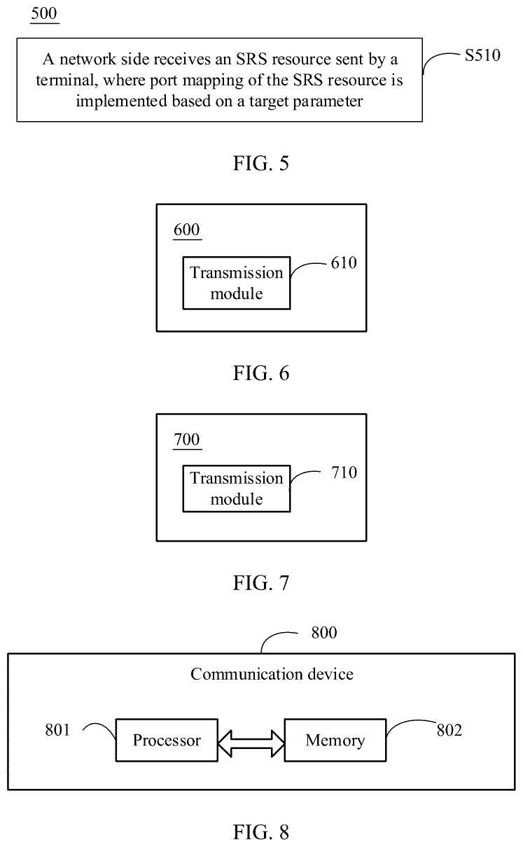

FIG. 6 is a schematic structural diagram of an apparatus 600 for port mapping of an SRS resource according to an example embodiment of this application. The apparatus includes a transmission module 610, configured to send an SRS resource. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

Optionally, in a case that the target parameter includes the first parameter, the transmission module is further configured to perform at least one of following: receiving first signaling, where the first signaling indicates a third parameter, there is an association relationship between the third parameter and M first parameters, and M is an integer greater than or equal to 1 and less than or equal to N; and receiving second signaling, where the second signaling indicates L first parameters, and L is an integer greater than or equal to 1 and less than or equal to N, where N is a number of ports of the SRS resource.

Optionally, the association relationship between the third parameter and the M first parameters is determined through at least one of following: default agreement between a network side and the terminal; autonomous determining by the terminal; and configuration by a network side.

Optionally, in a case that L is an integer less than N, at least a part of N ports share one of the first parameters.

Optionally, in a case that N ports of the SRS resource correspond to a plurality of the first parameters, the plurality of first parameters satisfy at least one of following: Values of the plurality of first parameters are obtained by evenly dividing a preset value range according to a specific value; and a total number of the plurality of first parameters does not exceed a preset value, where the preset value is related to at least one of following: the number of ports of the SRS resource, a number of cyclic shifts, and a number of comb offsets.

Optionally, in a case that N ports of the SRS resource correspond to a same first parameter, the N ports are multiplexed in a first multiplexing scheme, where the first multiplexing scheme includes at least one of following: multiplexed based on a cyclic shift; multiplexed based on a comb offset; and multiplexed in time domain, based on a symbol occupied by the SRS resource.

Optionally, in a case that at least a part of the N ports of the SRS resource correspond to different first parameters, the N ports are multiplexed in a second multiplexing scheme, where the second multiplexing scheme includes at least one of following: multiplexed based on a cyclic shift; multiplexed based on a comb offset; multiplexed in time domain, based on a symbol occupied by the SRS resource; and multiplexed based on the first parameter.

Optionally, when N ports of the SRS resource occupy a plurality of symbols, sequence values of the SRS resource mapped to the plurality of symbols are related to the first parameter.

Optionally, the sequence values of the SRS resource mapped to the plurality of symbols are determined by a time parameter, and the time parameter includes at least one of following: a symbol index, a period of symbols, and a number of symbols.

Optionally, in a case that the target parameter includes the OCC sequence-related parameter, a port of the SRS resource corresponds to a target OCC sequence, and the target OCC sequence is determined based on the OCC sequence-related parameter.

Optionally, determining the target OCC sequence based on the OCC sequence-related parameter includes at least one of following: Different target OCC sequences correspond to different OCC sequence-related parameters; and when the OCC sequence-related parameter is not configured, all elements in the target OCC sequence are 1.

Optionally, each element in the target OCC sequence is in a one-to-one correspondence with a symbol occupied by the SRS resource.

Optionally, a length of the target OCC sequence is determined based on at least one of following: a number of repetitions of the SRS resource; a number of symbols occupied by the SRS resource; a number of slots occupied by the SRS resource; and a fourth parameter, where the fourth parameter is a parameter other than the number of repetitions of the SRS resource, the number of symbols occupied by the SRS resource, and the number of slots occupied by the SRS resource.

Optionally, in a case that the target parameter includes the second parameter, during the port mapping performed for the SRS resource based on a target parameter, the second parameter is used to determine any one of following: a symbol interval between symbols occupied by the SRS resource; and a punctured symbol between the symbols occupied by the SRS resource.

Optionally, in a case that the port mapping is performed for the SRS resource based on the symbol interval, a mapping manner includes at least one of following: A start symbol position for performing the port mapping for the SRS resource is determined by a first symbol offset; and in a case that the SRS resource is configured with a repetition factor R, the port mapping is repeated R times based on the symbol interval, or is repeated R/X times based on the symbol interval, where R/X is an integer, and X represents the symbol interval.

Optionally, the punctured symbol is determined based on one of following: a bitmap (bitmap) indication; and a start position and a puncturing length of the punctured symbol.

The apparatus 600 for port mapping of an SRS resource in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing enumerated types of the terminal 11, and the another device may be a server, a network attached storage (Network Attached Storage, NAS), or the like. This is not specifically limited in this embodiment of this application.

The apparatus for port mapping of the SRS resource provided in this embodiment of this application can implement the processes implemented in the method embodiments shown in FIG. 2 and FIG. 3, and a same technical effect is achieved. To avoid repetition, details are not described herein again.

FIG. 7 is a schematic structural diagram of an apparatus 700 for port mapping of an SRS resource according to an example embodiment of this application. The apparatus includes a transmission module 710, configured to receive an SRS resource sent by a terminal. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

Optionally, in a case that the target parameter includes the first parameter, the transmission module 710 is further configured to perform at least one of following: sending first signaling to the terminal, where the first signaling is used to indicate a third parameter, there is an association relationship between the third parameter and M first parameters, and M is an integer greater than or equal to 1 and less than or equal to N; and sending second signaling to the terminal, where the second signaling is used to indicate L first parameters, and L is an integer greater than or equal to 1 and less than or equal to N, where N is a number of ports of the SRS resource.

Optionally, the association relationship between the third parameter and the M first parameters is determined through at least one of following: default agreement between a network side and the terminal; reporting by the terminal; and configuration by a network side.

The apparatus 700 for port mapping of an SRS resource in this embodiment of this application may be an electronic device, for example, an electronic device with an operating system, or may be a component in the electronic device, for example, an integrated circuit or a chip. The electronic device may be a network side device, or a device other than the network side device. For example, the network side device may include but is not limited to the enumerated types of network side device 12, and the another device may be a server, a network attached storage (Network Attached Storage, NAS), or the like. This is not specifically limited in this embodiment of this application.

The apparatus for port mapping of the SRS resource provided in this embodiment of this application can implement the processes implemented in the method embodiment shown in FIG. 5, and a same technical effect is achieved. To avoid repetition, details are not described herein again.

As shown in FIG. 8, an embodiment of this application further provides a communication device 800, including a processor 801 and a memory 802, and the memory 802 stores a program or an instruction that can be run on the processor 801. For example, in a case that the communication device 800 is a terminal, when the program or the instruction is executed by the processor 801, the steps of the foregoing embodiments of the methods for port mapping of the SRS resource are implemented, and a same technical effect can be achieved. In a case that the communication device 800 is a network side device, when the program or the instruction is executed by the processor 801, the steps of the foregoing embodiments of the methods for port mapping of the SRS resource are implemented, and a same technical effect can be achieved. To avoid repetition, details are not described herein again.

An embodiment of this application further provides a terminal, including a processor and a communication interface, where the communication interface is coupled to the processor, and the processor is used to run a program or an instruction, to implement the steps of the method embodiments shown in FIG. 2 and FIG. 3. The terminal embodiment is corresponding to the method embodiments on the terminal side, each implementation process and implementation of the method embodiments can be applied to the terminal embodiment, and a same technical effect can be achieved. Specifically, FIG. 7 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

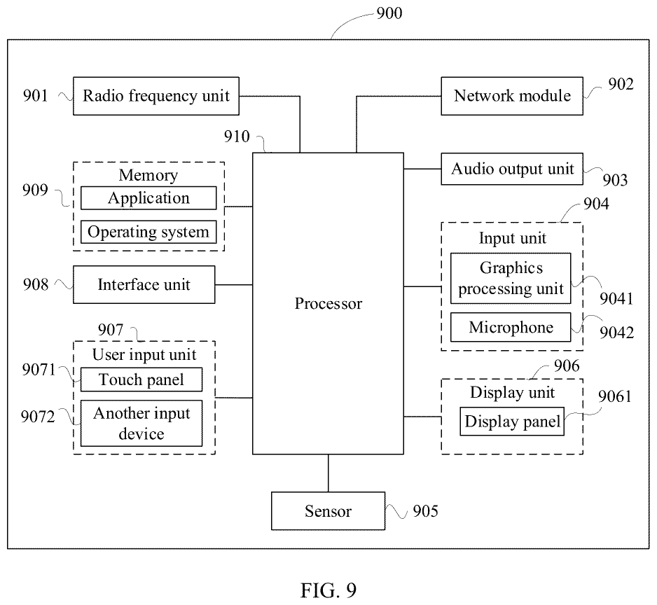

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (Graphics Processing Unit, GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, the modem processor may alternatively not be integrated into the processor 910.

The radio frequency unit 901 is configured to send an SRS resource. Port mapping of the SRS resource is implemented based on a target parameter, the target parameter includes at least one of a first parameter and a second parameter, the first parameter includes a Doppler domain-related parameter or an orthogonal cover code OCC sequence-related parameter, and the second parameter includes a time domain-related parameter.

Optionally, in a case that the target parameter includes the first parameter, the radio frequency unit 901 is further configured to perform at least one of following: receiving first signaling, where the first signaling indicates a third parameter, there is an association relationship between the third parameter and M first parameters, and M is an integer greater than or equal to 1 and less than or equal to N; and receiving second signaling, where the second signaling indicates L first parameters, and L is an integer greater than or equal to 1 and less than or equal to N, where N is a number of ports of the SRS resource.

Optionally, the association relationship between the third parameter and the M first parameters is determined through at least one of following: default agreement between a network side and the terminal; autonomous determining by the terminal; and configuration by a network side.

Optionally, in a case that L is an integer less than N, at least a part of N ports share one of the first parameters.

Optionally, in a case that N ports of the SRS resource correspond to a plurality of the first parameters, the plurality of first parameters satisfy at least one of following: Values of the plurality of first parameters are obtained by evenly dividing a preset value range according to a specific value; and a total number of the plurality of first parameters does not exceed a preset value, where the preset value is related to at least one of following: the number of ports of the SRS resource, a number of cyclic shifts, and a number of comb offsets.

Optionally, in a case that N ports of the SRS resource correspond to a same first parameter, the N ports are multiplexed in a first multiplexing scheme, where the first multiplexing scheme includes at least one of following: multiplexed based on a cyclic shift; multiplexed based on a comb offset; and multiplexed in time domain, based on a symbol occupied by the SRS resource.

Optionally, in a case that at least a part of the N ports of the SRS resource correspond to different first parameters, the N ports are multiplexed in a second multiplexing scheme, where the second multiplexing scheme includes at least one of following: multiplexed based on a cyclic shift; multiplexed based on a comb offset; multiplexed in time domain, based on a symbol occupied by the SRS resource; and multiplexed based on the first parameter.

Optionally, when N ports of the SRS resource occupy a plurality of symbols, sequence values of the SRS resource mapped to the plurality of symbols are related to the first parameter.

Optionally, the sequence values of the SRS resource mapped to the plurality of symbols are determined by a time parameter, and the time parameter includes at least one of following: a symbol index, a period of symbols, and a number of symbols.

Optionally, in a case that the target parameter includes the OCC sequence-related parameter, a port of the SRS resource corresponds to a target OCC sequence, and the target OCC sequence is determined based on the OCC sequence-related parameter.

Optionally, determining the target OCC sequence based on the OCC sequence-related parameter includes at least one of following: Different target OCC sequences correspond to different OCC sequence-related parameters; and when the OCC sequence-related parameter is not configured, all elements in the target OCC sequence are 1.

Optionally, each element in the target OCC sequence is in a one-to-one correspondence with a symbol occupied by the SRS resource.

Optionally, a length of the target OCC sequence is determined based on at least one of following: a number of repetitions of the SRS resource; a number of symbols occupied by the SRS resource; a number of slots occupied by the SRS resource; and a fourth parameter, where the fourth parameter is a parameter other than the number of repetitions of the SRS resource, the number of symbols occupied by the SRS resource, and the number of slots occupied by the SRS resource.

Optionally, in a case that the target parameter includes the second parameter, during the port mapping performed for the SRS resource based on a target parameter, the second parameter is used to determine any one of following: a symbol interval between symbols occupied by the SRS resource; and a punctured symbol between the symbols occupied by the SRS resource.

Optionally, in a case that the port mapping is performed for the SRS resource based on the symbol interval, a mapping manner includes at least one of following: A start symbol position for performing the port mapping for the SRS resource is determined by a first symbol offset; and in a case that the SRS resource is configured with a repetition factor R, the port mapping is repeated R times based on the symbol interval, or is repeated R/X times based on the symbol interval, where R/X is an integer, and X represents the symbol interval.

Optionally, the punctured symbol is determined based on one of following: a bitmap (bitmap) indication; and a start position and a puncturing length of the punctured symbol.

It may be understood that, for an implementation process of the foregoing implementations, reference may be made to the related descriptions in the foregoing embodiments of the methods for port mapping of the SRS resource, and a same or corresponding technical effect is achieved. To avoid repetition, details are not described herein again.

An embodiment of this application further provides a network side device, including a processor and a communication interface, where the communication interface is coupled to the processor, and the processor is used to run a program or an instruction, to implement the steps of the method embodiment shown in FIG. 5. This network side device embodiment is corresponding to the foregoing method embodiments of the network side device. Each implementation process and implementation of the foregoing method embodiments is applicable to this network side device embodiment, and a same technical effect can be achieved.

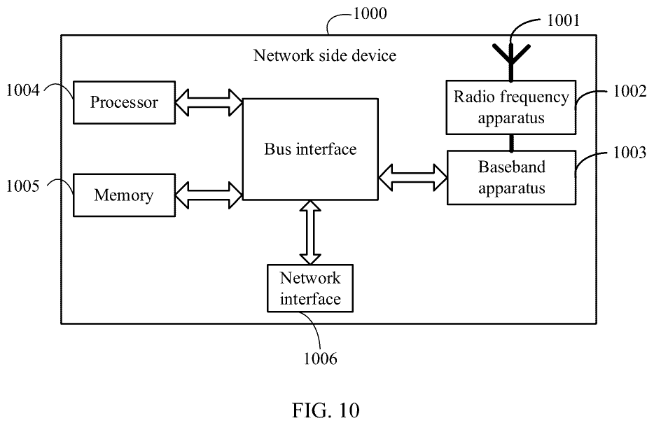

Specifically, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information through the antenna 1001.

In the foregoing embodiment, the method performed by the network side device may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 by using a bus interface, to invoke a program in the memory 1005 to perform the operations of the network device shown in the foregoing method embodiments.

The network side device may further include a network interface 1006, and the interface is, for example, a common public radio interface (Common Public Radio Interface, CPRI).

Specifically, the network side device 1000 in this embodiment of this application further includes an instruction or a program stored in the memory 1005 and capable of running on the processor 1004. The processor 1004 invokes the instruction or program in the memory 1005 to perform the method performed by the modules shown in FIG. 7, and a same technical effect can be achieved. To avoid repetition, details are not described herein again.

An embodiment of this application further provides a readable storage medium. The readable storage medium stores a program or an instruction, and when the program or the instruction is executed by a processor, the processes of the foregoing embodiments of the methods for port mapping of the SRS resource are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface, where the communication interface is coupled to the processor, and the processor is configured to run a program or an instruction to implement the processes of the foregoing embodiments of the methods for port mapping of the SRS resource, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiments of the methods for port mapping of the SRS resource, and a same technical effect can be achieved. To avoid repetition, details are not described herein again.

An embodiment of this application further provides a wireless communication system, including a terminal and a network side device. The terminal may be configured to implement the processes of the embodiments of the methods 200 and 300 for port mapping of the SRS resource, and the network side device may be configured to implement the processes of the foregoing embodiment of the method 500 for port mapping of the SRS resource, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the foregoing method embodiments may be implemented by using a computer software product; and software in addition to a necessary universal hardware platform or by hardware only. The computer software product is stored in a storage medium (such as a ROM, a RAM, a magnetic disk, or an optical disc) and includes several instructions for instructing the terminal or the network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make implementations in many forms without departing from the purpose of this application and the protection scope of the claims, all of which fall within the protection of this application.

1. A method for port mapping of a sounding reference signal SRS resource, comprising:
sending, by a terminal, an SRS resource, wherein port mapping of the SRS resource is implemented based on a target parameter; and
the target parameter comprises at least one of a first parameter or a second parameter, the first parameter comprises a Doppler domain-related parameter or an orthogonal cover code OCC sequence-related parameter, and the second parameter comprises a time domain-related parameter.

2. The method according to claim 1, wherein in a case that the target parameter comprises the first parameter, the method further comprises at least one of following:
receiving first signaling, wherein the first signaling indicates a third parameter, there is an association relationship between the third parameter and M first parameters, and M is an integer greater than or equal to 1 and less than or equal to N; or
receiving second signaling, wherein the second signaling indicates L first parameters, and L is an integer greater than or equal to 1 and less than or equal to N, wherein N is a number of ports of the SRS resource.

3. The method according to claim 2, wherein the association relationship between the third parameter and the M first parameters is determined through at least one of following:
default agreement between a network side and the terminal;
autonomous determining by the terminal; or
configuration by a network side.

4. The method according to claim 2, wherein in a case that L is an integer less than N, at least a part of N ports share one of the first parameters.

5. The method according to claim 2, wherein in a case that N ports of the SRS resource correspond to a plurality of the first parameters, the plurality of first parameters satisfy at least one of following:
values of the plurality of first parameters are obtained by evenly dividing a preset value range according to a specific value; or
a total number of the plurality of first parameters does not exceed a preset value, wherein the preset value is related to at least one of following: the number of ports of the SRS resource, a number of cyclic shifts, or a number of comb offsets.

6. The method according to claim 1, wherein in a case that N ports of the SRS resource correspond to a same first parameter, the N ports are multiplexed in a first multiplexing scheme, wherein
the first multiplexing scheme comprises at least one of following:
multiplexed based on a cyclic shift;
multiplexed based on a comb offset; or
multiplexed in time domain, based on a symbol occupied by the SRS resource.

7. The method according to claim 1, wherein in a case that at least a part of N ports of the SRS resource correspond to different first parameters, the N ports are multiplexed in a second multiplexing scheme, wherein
the second multiplexing scheme comprises at least one of following:
multiplexed based on a cyclic shift;
multiplexed based on a comb offset;
multiplexed in time domain, based on a symbol occupied by the SRS resource; or
multiplexed based on the first parameter.

8. The method according to claim 1, wherein when N ports of the SRS resource occupy a plurality of symbols, sequence values of the SRS resource mapped to the plurality of symbols are related to the first parameter.

9. The method according to claim 8, wherein the sequence values of the SRS resource mapped to the plurality of symbols are determined by a time parameter, and the time parameter comprises at least one of following: a symbol index, a period of symbols, or a number of symbols.

10. The method according to claim 1, wherein in a case that the target parameter comprises the OCC sequence-related parameter, a port of the SRS resource corresponds to a target OCC sequence, and the target OCC sequence is determined based on the OCC sequence-related parameter.

11. The method according to claim 10, wherein determining the target OCC sequence based on the OCC sequence-related parameter comprises at least one of following:
different target OCC sequences correspond to different OCC sequence-related parameters; or
when the OCC sequence-related parameter is not configured, all elements in the target OCC sequence are 1.

12. The method according to claim 11, wherein each element in the target OCC sequence is in a one-to-one correspondence with a symbol occupied by the SRS resource.

13. The method according to claim 11, wherein a length of the target OCC sequence is determined based on at least one of following:
a number of repetitions of the SRS resource;
a number of symbols occupied by the SRS resource;
a number of slots occupied by the SRS resource; or
a fourth parameter, wherein the fourth parameter is a parameter other than the number of repetitions of the SRS resource, the number of symbols occupied by the SRS resource, and the number of slots occupied by the SRS resource.

14. The method according to claim 2, wherein in a case that the target parameter comprises the second parameter, the second parameter is used to determine any one of following:
a symbol interval between symbols occupied by the SRS resource; and
a punctured symbol between the symbols occupied by the SRS resource.

15. The method according to claim 14, wherein in a case that port mapping is performed for the SRS resource based on the symbol interval, a mapping manner comprises at least one of following:
a start symbol position for performing the port mapping for the SRS resource is determined by a first symbol offset; or
in a case that the SRS resource is configured with a repetition factor R, the port mapping is repeated R times based on the symbol interval, or is repeated R/X times based on the symbol interval, wherein R/X is an integer, and X is the symbol interval.

16. The method according to claim 14, wherein the punctured symbol is determined based on one of following:
a bitmap indication; and
a start position and a puncturing length of the punctured symbol.

17. A method for port mapping of a sounding reference signal SRS resource, comprising:
receiving, by a network side device, an SRS resource sent by a terminal, wherein
port mapping of the SRS resource is implemented based on a target parameter, the target parameter comprises at least one of a first parameter or a second parameter, the first parameter comprises a Doppler domain-related parameter or an orthogonal cover code OCC sequence-related parameter, and the second parameter comprises a time domain-related parameter.

18. The method according to claim 17, wherein in a case that the target parameter comprises the first parameter, the method further comprises at least one of following:
sending first signaling to the terminal, wherein the first signaling is used to indicate a third parameter, there is an association relationship between the third parameter and M first parameters, and M is an integer greater than or equal to 1 and less than or equal to N; or
sending second signaling to the terminal, wherein the second signaling is used to indicate L first parameters, and L is an integer greater than or equal to 1 and less than or equal to N, wherein
N is a number of ports of the SRS resource.

19. A terminal, comprising a processor and a memory, wherein the memory stores a program or an instruction that is capable of running on the processor, and when the program or the instruction is executed by the processor, a method for port mapping of a sounding reference signal SRS resource is implemented, the method comprising:
sending an SRS resource, wherein port mapping of the SRS resource is implemented based on a target parameter; and
the target parameter comprises at least one of a first parameter or a second parameter, the first parameter comprises a Doppler domain-related parameter or an orthogonal cover code OCC sequence-related parameter, and the second parameter comprises a time domain-related parameter.

20. A network side device, comprising a processor and a memory, wherein the memory stores a program or an instruction that is capable of running on the processor, and when the program or the instruction is executed by the processor, the steps of the method according to claim 17 are implemented.
